(19) United States
(12) Patent Application Publication
(10) Pub. No.: US 2021/0131747 A1
(43) Pub. Date: May 6, 2021

(54) Heat Exchanger

(71) Applicants: Helmholtz-Zentrum Dresden - Rossendorf e.V., Dresden (DE); Technische Universität Dresden, Dresden (DE)

(72) Inventors: Sebastian Unger, Dresden (DE); Uwe Hampel, Radeberg (DE)

(21) Appl. No.: 16/638,786

(22) PCT Filed: Aug. 3, 2018
(86) PCT No.: PCT/EP2018/071098

§ 371 Date: Feb. 13, 2020

(30) Foreign Application Priority Data
Aug. 16, 2017 (DE) 10 2017 214 261.8

(51) Int. Cl. F28F 1/02; F28F 1/28

(52) U.S. Cl. CPC F28F 1/02; F28F 2225/06; F28F 2215/10; F28F 1/28

(57) ABSTRACT

The invention relates to a heat exchanger having at least one partition and surface elements which project from at least one side of the partition and which enlarge the surface of the partition and around which a fluid can flow. The problem addressed by the present invention is that of proposing heat exchangers of low mass with high thermal transmission capacity. This problem is solved by means of a heat exchanger in which the surface elements are formed so as to project in the manner of fins from the partition, and the surface elements have reinforcement beads, wherein the reinforcement beads extend as far as the partition.

### CROSS REFERENCE TO RELATED APPLICATIONS

This application is the U.S. national stage of International Application No. PCT/EP2018/071098, filed on 2018-08-03. The international application claims the priority of DE 102017214261.8 filed on 2017-08-16; all applications are incorporated by reference herein in their entirety.

### BACKGROUND

The present invention relates to a heat exchanger having at least one partition, from which surface elements projecting on at least one side are arranged, around which elements a fluid can flow.

Heat exchangers are used in the prior art in various designs for transferring heat from one medium to another medium, with the two media remaining physically separate. According to the type of media, which are also referred to as fluids, heat exchangers can be subdivided, for example, into liquid-gas heat exchangers, liquid-liquid heat exchangers and gas-gas heat exchangers. In the field of liquid-gas heat exchangers, shell and tube heat exchangers having ribbed tubes are known, which are also referred to as ribbed tube heat exchangers. The liquid flows inside the tube and the gas flows around the tube on the outside. In this regard, the heat transfer coefficients of liquids are one to two orders of magnitude larger than that of gases. The surface of the tube is therefore externally enlarged by ribs, as a result of which there is a reduced heat transfer resistance on the gas side of said heat exchanger. In this way, the heat transfer resistances for both media are low. The ribs of ribbed tubes are frequently designed in the prior art as bulky projections which are connected to the partition of the heat exchanger. Large volumes of the ribs are linked to high material costs during production and a large weight of the heat exchangers. Heavy weights can be disadvantageous and undesirable, for example for use in vehicles. A high material consumption is disadvantageously associated with correspondingly high costs. A large wall thickness of the individual ribs, referred to below as rib thickness, leads to a lower number of ribs per ribbed tube when the ribs are at the same distance from one another than when thinner ribs are used. Limited heat transfer surfaces and low overall thermal performance are associated with a large rib thickness.

The document GB 436,656 discloses heat exchangers having ribbed tubes in which the ribs in the shape of three-dimensional surface elements have an enlarged surface. A disadvantage of said ribbed tubes is the increase in mass which is proportional to the volume of the three-dimensional structures and a limited overall thermal performance of the heat exchangers.

### SUMMARY

The invention relates to a heat exchanger having at least one partition and surface elements which project from at least one side of the partition and which enlarge the surface of the partition and around which a fluid can flow. The problem addressed by the present invention is that of proposing heat exchangers of low mass with high thermal transmission capacity. This problem is solved by means of a heat exchanger in which the surface elements are formed so as to project in the manner of fins from the partition, and the surface elements have reinforcement beads, wherein the reinforcement beads extend as far as the partition.

### DETAILED DESCRIPTION

The problem addressed by the present invention is therefore that of proposing heat exchangers of low mass with a high thermal performance.

This problem is solved by means of a heat exchanger of the type described at the outset, which is also designed in such a way that the surface elements are formed so as to project in the manner of fins from the partition and the surface elements have reinforcement beads, the reinforcement beads extending as far as the partition. “In the manner of fins” means that the surface elements extend at an angle larger than zero and less than or equal to 90° from the partition, and that the thickness of the surface elements, also referred to as wall thickness, is small relative to the area of the surface elements, the thickness being measured in parallel with the partition and perpendicularly to the face of the surface elements. Preferably, the surface elements extend perpendicularly from the partition wall. The surface elements are rigidly connected to the partition and are also rigid in themselves.

The surface elements which are used as ribs of the heat exchanger are divided into thin-walled face regions having a correspondingly low volume and low mass. The elements are divided by reinforcement beads having larger cross sections so as to increase heat conduction. This means that the reinforcement beads have a greater thickness than the surface regions. The reinforcement beads are oriented such that they direct the heat towards or away from the partition located between the two media depending on how the temperature gradient extends.

The heat exchanger can be a liquid-gas heat exchanger, for example a water-air heat exchanger. The heat exchanger may be formed as a ribbed tube heat exchanger in which the partition between the first fluid (e.g. water) and the second fluid (e.g. air) is formed by the tube wall of the tubes. The fluids, water and air, should be understood to be purely examples, which may also represent other liquid and gaseous fluids. The inside of the tubes may be in contact with a liquid first fluid. The heat transfer resistance is low at this interface due to the liquid state of matter of the first fluid. Correspondingly, there is no need for enlargement of the surfaces on the inside of the tubes. A gas flow is guided in the cross-flow, the main flow direction of which is perpendicular to the axis of the tube. The interfaces on the outside of the tubes which contact the gaseous second fluid have a higher heat transfer resistance per unit of area of the partition surface. In order to nevertheless achieve a low heat transfer resistance, the surface of the partition of the heat exchanger according to the invention is enlarged on at least this side by means of ribs in the form of the described surface elements. Such surface-enlarging surface elements can also be arranged on both sides of the partition in other heat exchangers according to the invention, for example in a gas-gas heat exchanger.

The following embodiments relate mainly to a liquid-gas heat exchanger having a surface which is enlarged only on one side on the gas side. However, the embodiments also apply, with the appropriate modifications, to other heat exchangers having surfaces of the partition which are enlarged on both sides, for which no embodiment is explicitly specified.

Specifically, the heat exchanger according to the invention may be a ribbed tube heat exchanger having at least one tube for the flow of a first fluid on the inside of the tube and for the flow of a second fluid around the outside of the tube, the outside being enlarged by surface elements which are referred to as ribs in ribbed tube heat exchangers. The surface elements or ribs are formed so as to project in the manner of fins from the tube and have reinforcement beads, the reinforcement beads extending such that they lead away from the tube.

The thermal conductivity of the ribs of ribbed tubes is a material property of the material used to produce the ribs. A large cross-sectional area is needed transversely to the direction of heat conduction for a large heat flow.

The heat exchanger according to the invention uses fin-like surface elements as ribs, which surface elements have reinforcement beads spaced apart from one another and face regions of small thickness between the reinforcement beads. The face regions have a high thermal resistance due to their small thicknesses. The reinforcement beads have, however, a larger cross section and a low thermal resistance, which is sufficiently low also for transporting heat over longer lengths. Heat is conducted in these surface elements in part in two stages: If, for example, the second fluid on the outside of the tube has a lower temperature level than the fluid on the inside of the tube, the heat is first conducted from the tube wall or other partitions into the reinforcement beads and from there further into the face regions between the reinforcement beads. A direct heat transmission from the tube wall into the face regions can also dominate in the immediate vicinity of the tube wall, while only portions of the heat are conducted to the reinforcement beads. The reinforcement beads contact, by its cross section, the tube or the tube wall or other partition and extend away from the tube. In other words, the reinforcement beads are orthogonal or at an angle with respect to the tube wall, but not parallel or otherwise spaced apart with respect to the tube wall.

In a round tube, the reinforcement beads may extend radially and in the case of flat partitions orthogonally to the partition such that the heat is conducted along a short distance from the partition or to the partition. For example, the reinforcement beads may also extend differently to the tube for geometrical or flow reasons. The reinforcement beads of the surface elements of the heat exchangers according to the invention may extend substantially through the entire surface element as far as an outer edge of the surface element. Alternatively, the reinforcement beads may also be formed only on a partition-side partial face of the surface element and end in front of the outer edge of the surface element remote from the partition. The cross section of the reinforcement beads may also increase in size towards the partition. The reinforcement beads may have circular or oval cross-sectional shapes. However, other cross-sectional shapes are also possible. The diameter of circular reinforcement beads may be at least twice as large as the thickness of face regions between the reinforcement beads.

The reinforcement beads of adjacent surface elements can be arranged offset from one another. A fluid, for example air, flowing transversely to the reinforcement beads is deflected at the reinforcement beads. A wave-like fluid flow can be generated by means of an offset of reinforcement beads which are located in adjacent surface elements. The wave-like fluid flow can also be considered to be a flow-efficient turbulence. An increased convective heat transfer from the surface elements and partitions to the fluid which flows around or vice versa can be achieved by means of turbulences. Good heat conduction due to the presence of the reinforcement beads results in a relatively large temperature difference between the surface element and the medium surrounding the surface element. As a result of the large temperature difference, a large heat flow between the surface element and the surrounding medium is achieved and, as a result, a large thermal performance of the heat exchanger according to the invention is achieved. Adjacent surface elements may be attached to a partition, for example on a tube. However, surface elements coming from adjacent partitions may also clasp one another in a comb-like manner.

According to one embodiment of the heat exchanger according to the invention, the tube of a ribbed tube heat exchanger is formed as an oval tube, the cross section of which is formed from two semicircles and two straight lines connecting the semicircles. The surface elements have an oval shape and are arranged in an orthogonal plane, i.e. orthogonally to the axis of the tube. The concept of the present invention can be advantageously implemented on the oval tubes. At the surface regions of the straight regions of the oval tube, the reinforcement beads can be positioned almost perpendicularly to the flow, in parallel with and at a constant distance from one another. In this case, a maximised convective heat transfer between adjacent surface elements can be achieved. By means of the offset reinforcement beads in opposing, i.e. adjacent, surface elements, a wave-like flow can be formed which further improves the heat transfer. The length of the straight lines of the oval tube cross section may be at least as large as the diameter of the semicircle thereof, in particular 2.5 times as large. A large heat transfer can be advantageously achieved at the large straight regions of the oval tube and the regions of the surface element which adjoin thereto. For mechanical and flow reasons within the tube, the oval tube or the oval flat tube cannot arbitrarily be formed flat.

The individual aspects presented of embodiments of the heat exchanger according to the invention can also be combined in some other way at the discretion of a person skilled in the art, without departing from the scope of the invention presented and claimed here. Features described one after another should not be misunderstood to be an inseparable combination of features, but rather should be understood to be a list of individual features.

### BRIEF DESCRIPTION OF THE DRAWINGS

The present invention will be explained in more detail below with reference to figures, in which

FIG. 1 is a perspective view of a heat exchanger according to the invention,

FIG. 2 shows a fluid flow in the heat exchanger according to the invention,

FIG. 3 is a view of a ribbed tube heat exchanger according to the invention in a viewing direction along the tube and

FIG. 4 is a view of the ribbed tube heat exchanger according to the invention in a viewing direction which is transverse to the tube.

### DETAILED DESCRIPTION OF THE PREFERRED EMBODIMENTS

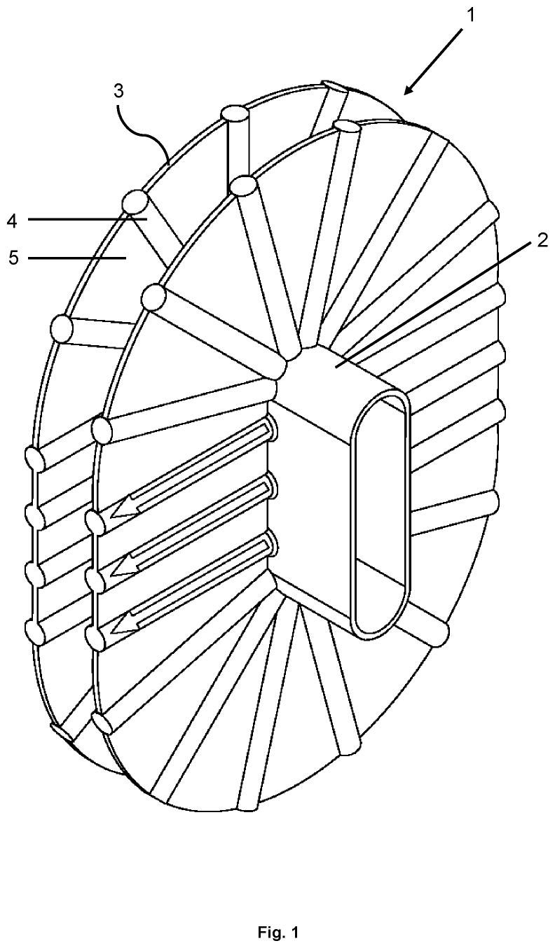

FIG. 1 shows a detail of a heat exchanger 1 according to the invention, specifically a ribbed tube heat exchanger, in a perspective view. The oval tube 2 can be seen in the centre of the object illustrated. The walls of the tube 2 are partitions between a first fluid inside the tube 2 and a second fluid outside the tube 2. Heat is exchanged between the first and the second fluid through the partition or the tube wall without the first and the second fluid coming into contact with one another materially. On the outside, the tube 2 has surface-enlarging ribs which give the ribbed tube heat exchanger its name. In the heat exchanger 1 according to the invention illustrated here, the ribs connected to the tube are formed as substantially two-dimensional surface elements 3 of low volume. In the illustrated embodiment, the surface elements 3 have pin-shaped reinforcement beads 4 having a round cross section. These reinforcement beads 4 extend from the tube 2 as far as the outer edge of the surface elements 3. Between the reinforcement beads 4, the surface element 3 has face regions 5 which have a smaller thickness than the reinforcement beads 4.

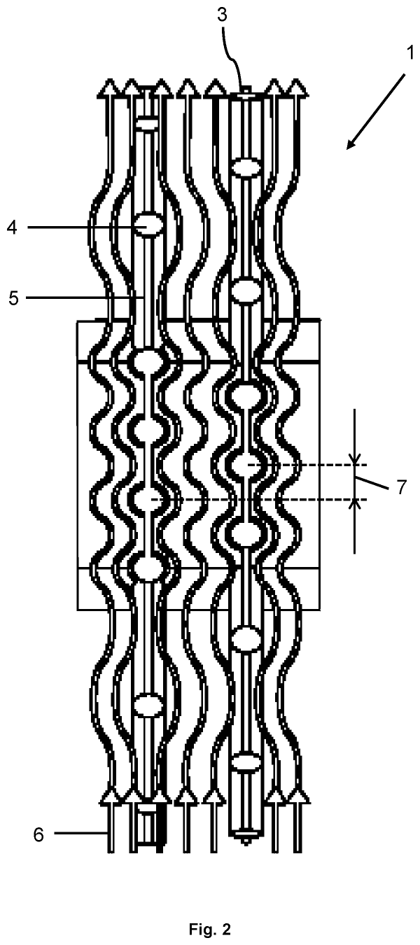

FIG. 2 shows a detail of the heat exchanger from FIG. 1 in a schematic side view of the tube 2. Like reference numerals in the figures indicate the same or similar elements. To avoid repetition, reference is made to the description of FIG. 1. In FIG. 2, the flow of the second fluid outside the tube 2 is illustrated schematically using flow lines 6. The reinforcement beads 4 interfere with a laminar flow between adjacent surface elements 3 by causing turbulences. The turbulences improve the heat transfer between the second fluid and the surface element 3. On the planar side of the oval tube 2, the reinforcement beads 4 of adjacent surface elements 3 are arranged in parallel with one another. In addition, they are each arranged at an offset 7 from one another in the flow direction, which extends from the bottom to the top in the illustration. By means of the offset 7, the turbulences of the individual reinforcement beads 4 are superimposed to form the flow-efficient wave path outlined by the flow lines 6.

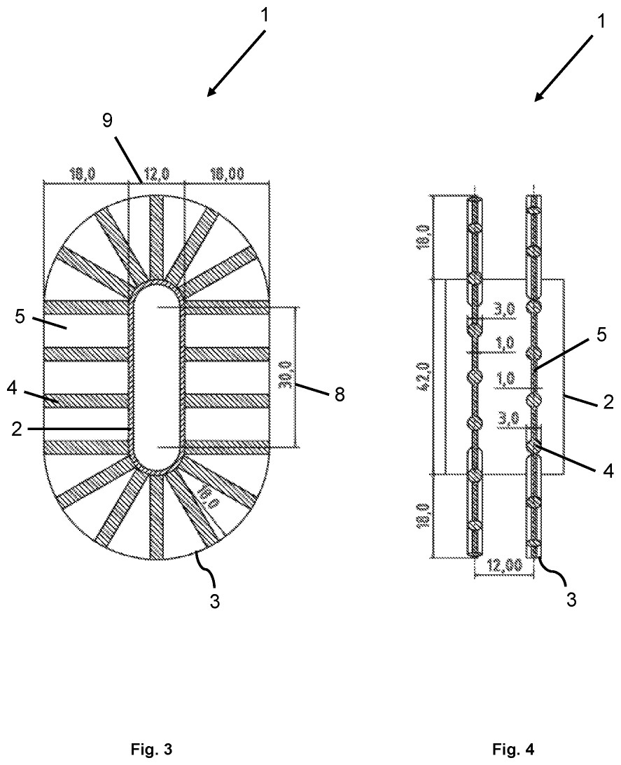

In FIGS. 3 and 4, a very specific design example of the ribbed tube heat exchanger of FIGS. 1 and 2 is illustrated in two different views along the tube 2 and transversely thereto. The tube 2 is here designed as an oval tube which offers, with the same cross section, a lower resistance to the flow illustrated in FIG. 2 by the flow lines 6 than a round tube of the same cross-sectional size. The specific oval tube has an outer diameter 9 of 12 millimetres of the semicircular wall portions thereof and a length 8 of the straight side regions of 30 millimetres. For scaling the tube, it can be generalised that the ratio of the straight length 8 to the diameter 9 is 2.5. The exact size of this ratio can be used as an optimisation parameter in designing the heat exchanger based on predefined framework conditions. It can be seen in FIG. 4 that the face regions 5 have a small thickness of only 1 millimetre and the reinforcement beads 4 having a maximum thickness of 3 mm have an enlarged cross section or a thickness three times larger compared with the face regions 5.

It can be seen in the detail from FIG. 4 that the left surface element 3 has only three reinforcement beads 4 on the planar surface region of the oval tube 2. The right surface element 3 has, however, four reinforcement beads 4 in the same region. Due to the different number of reinforcement beads 4, the offset 7 is realised and ultimately also the flow path outlined in FIG. 2 by the flow lines 6. Furthermore, the offset of the reinforcement beads ensures different temperature profiles and thus large temperature differences between the fluid 2 and a surface element 3 in each case and therefore large heat flux densities are possible.

In the illustrated embodiments, the adjacent surface elements 3 are mounted on a tube 2. In other examples (not shown), adjacent surface elements 3 are mounted on adjacent tubes 2 and the ribs of adjacent tubes engage in one another in a comb-like manner. Further embodiments can be derived by a person skilled in the art from the above examples by adapting to a given statement of the problem.

### LIST OF REFERENCE NUMERALS

1 Heat exchanger

2 Tube

3 Surface element

4 Reinforcement bead of the surface element

5 Face region of the surface element

6 Flow lines of a fluid between adjacent surface elements

7 Offset of reinforcement beads

8 Straight line of the oval tube cross section

9 Diameter of the semicircle in the oval tube cross section

1. Heat exchanger (1) comprising at least one partition and surface elements (3) which project from at least one side of the partition and which enlarge the surface of the partition and around which a fluid can flow, the surface elements (3) being formed so as to project in the manner of fins from the partition and the surface elements (3) having reinforcement beads (4) and face regions (5) located between the reinforcement beads (4), the reinforcement beads (4) extending as far as the partition, characterised in that the reinforcement beads (4) have a circular or oval cross-sectional shape.

2. Heat exchanger (1) according to claim 1, characterised in that the heat exchanger (1) is a ribbed tube heat exchanger having at least one tube (2) for the flow of a first fluid inside the tube (2) and having surface elements (3) which enlarge the surface of the tube (2) on the outside and around which a second fluid can flow in the cross-flow to the fluid 1, the tube (2) forming the partition of the heat exchanger (1).

3. Heat exchanger (1) according to claim 2, characterised in that the reinforcement beads (4) extend orthogonally to the surface of the tube (2).

4. Heat exchanger (1) according to claim 1, characterised in that the reinforcement beads (4) extend through the entire surface element (3) as far as an outer edge of the surface element (3).

5. Heat exchanger (1) according to claim 1, characterised in that the reinforcement beads (4) have a circular cross section and the diameter of the reinforcement beads is at least twice as large as the thickness of the face regions (5) between the reinforcement beads (4) of the surface elements (3).

6. Heat exchanger (1) according to claim 1, characterised in that the reinforcement beads (4) of adjacent surface elements (3) are offset from one another so as to form an offset (7) in a flow direction of the second fluid between the surface elements (3).

7. Heat exchanger (1) according to claim 2, characterised in that the tube (2) of the ribbed tube heat exchanger is formed as an oval tube, the cross section of which is formed from two semicircles and two straight lines connecting the semicircles, the surface elements (3) having an oval shape are arranged in a plane which is orthogonal to a longitudinal axis of the tube and adjacent surface elements (3) are arranged in parallel with one another.

8. Heat exchanger (1) according to claim 7, characterised in that the length of the straight lines (8) of the cross section of the oval tube is at least as large as the diameter (9) of the semicircle of the cross section of the oval tube, in particular 2.5 times as large.

9. Heat exchanger (1) according to claim 6, characterised in that the tube (2) of the ribbed tube heat exchanger is formed as an oval tube, the cross section of which is formed from two semicircles and two straight lines connecting the semicircles, the surface elements (3) having an oval shape are arranged in a plane which is orthogonal to a longitudinal axis of the tube and adjacent surface elements (3) are arranged in parallel with one another.

10. Heat exchanger (1) according to claim 9, characterised in that the length of the straight lines (8) of the cross section of the oval tube is at least as large as the diameter (9) of the semicircle of the cross section of the oval tube, in particular 2.5 times as large.
